(19) United States
(12) Patent Application Publication
(10) Pub. No.: US 2022/0110732 A1
(43) Pub. Date: Apr. 14, 2022

(54) RIGID SALIVA EJECTOR

(71) Applicants: Karrie Lynn Velky, Ely, IA (US); Chris J. Carron, Bloomsdale, MO (US); Bradley P. Griffin, Greenville, NC (US)

(72) Inventors: Karrie Lynn Velky, Ely, IA (US); Chris J. Carron, Bloomsdale, MO (US); Bradley P. Griffin, Greenville, NC (US)

(21) Appl. No.: 17/499,355

(22) Filed: Oct. 12, 2021

Related U.S. Application Data
(60) Provisional application No. 63/090,495, filed on Oct. 12, 2020.

(51) Int. Cl. A61C 17/10; A61C 17/08

(52) U.S. Cl. CPC A61C 17/10; A61C 17/08

(57) ABSTRACT

A saliva ejector having a first member with a first end and a second end and a second member rotatably and removably connected to the first member. The first member has a first section that extends from the first end and terminates in a second section that is angled in relation to the first section. The second member has a first working end that is perpendicular in relation to a second open end. The first working end has a plurality of slits.

### CROSS REFERENCE TO RELATED APPLICATION

This application claims the benefit of U.S. Provisional Application Ser. No. 63/090,495 filed Oct. 12, 2020, the contents of this application is hereby incorporated by reference in its entirety.

### BACKGROUND OF THE INVENTION

The present invention is directed to a rigid saliva ejector. Saliva ejectors are well-known in the art and are used during dental procedures to suction infectious fluids from a patient's mouth.

Traditionally, a saliva ejector has been a single piece apparatus that is attached to a dental slow vacuum evacuation (SVE) line. Currently, saliva ejectors are disposable, made from a flexible plastic with an inner flexible wire to help keep its shape when bent by an operator. The ejector can be bent many times, in many different directions and shapes, to position the tip for optimal suction and retract the cheek and tongue. After use, the ejector is then disposed. The problem with current saliva ejectors is that they are not well suited for optimal suction or retraction of the patient's cheek or tongue as, based on their traditional design, they are too flexible and will not hold their shape. Therefore, a need exists in the art for a device that addresses these deficiencies.

An objective of the present is to provide a saliva ejector that is better suited for retraction.

Another objective of the present invention is to provide a saliva ejector that is better suited for optimal suction.

These and other objectives will be apparent to one having ordinary skill in the art based upon the following written description, drawings and claims.

### SUMMARY OF THE INVENTION

A saliva ejector having a first member with a first end and a second end. The first member includes a first section that extends from the first end and terminates in a second section that is angled in relation to the first section. A second member is rotatably and removably connected to the second end of the first member and has a first working end that is perpendicular in relation to a second open end. In one example the first section of the first member is straight and the second section is ninety degrees in relation to the first section.

The first working end of the second member has a plurality of slits adapted to allow for the evacuation of fluid from an individual's mouth. The second open end of the second member is connected to the second end of the first member. In one example the second member is connected to the first member by a friction fit. In another example the second open end of the second member has a plurality of stops positioned on an inner surface of the second open end that selectively align and engage with a plurality of locking grooves on the second end of the first member. As a result, the second member is rotated in relation to the first member to create multiple positions including one where the saliva ejector forms an S-shape.

### BRIEF DESCRIPTION OF THE DRAWINGS

FIG. 1 is a perspective view of a saliva ejector;

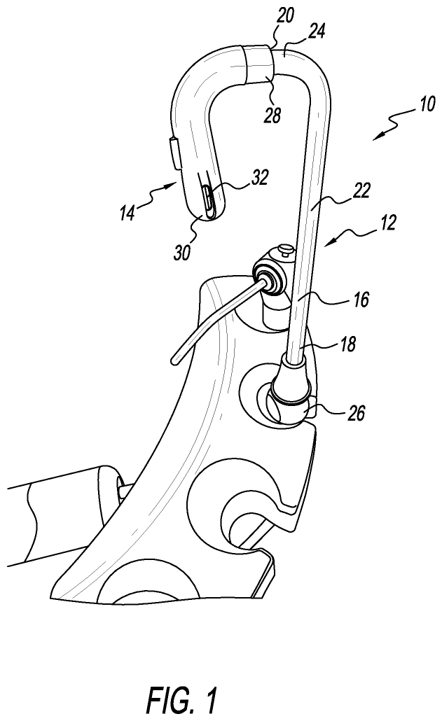

FIG. 2 is a perspective view of a second member of a saliva ejector;

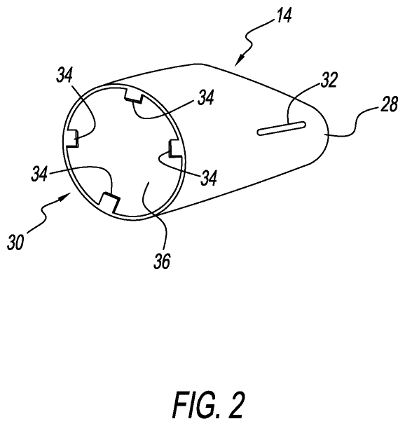

FIG. 3 is a perspective view of a saliva ejector;

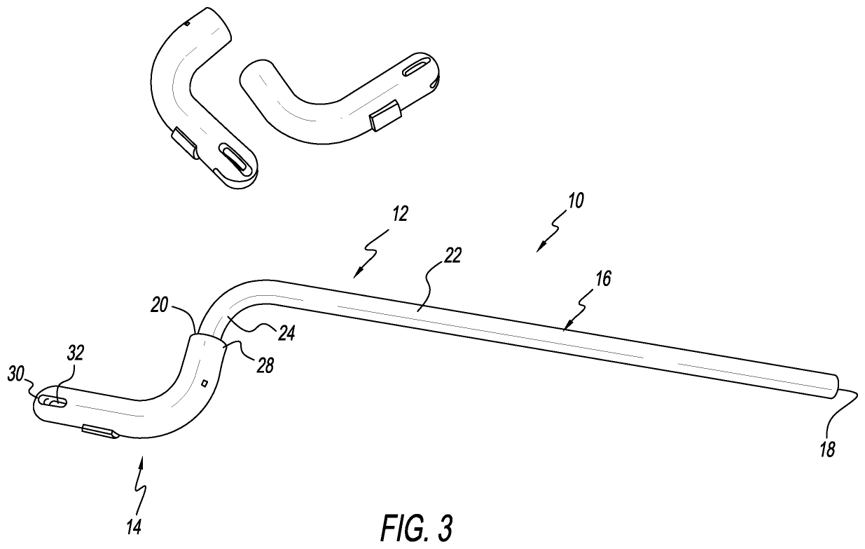

FIG. 4 is a perspective view of a saliva ejector; and

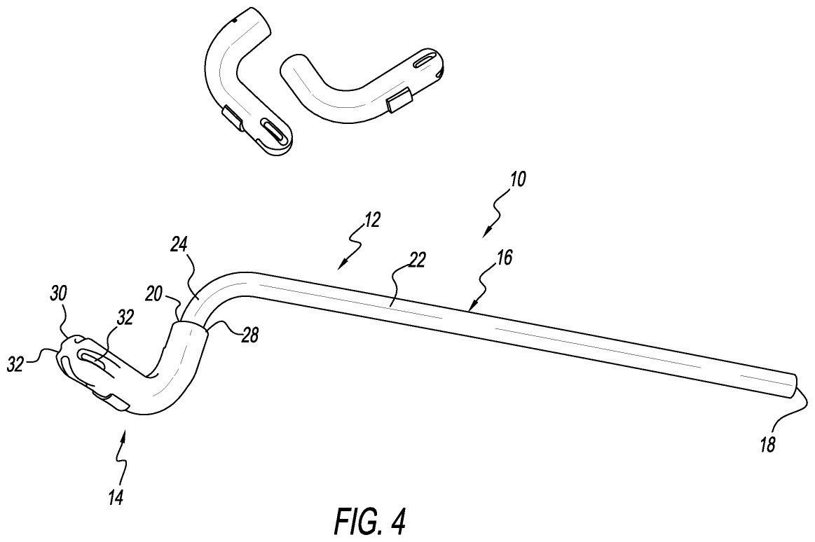

FIG. 5 is a perspective view of a saliva ejector.

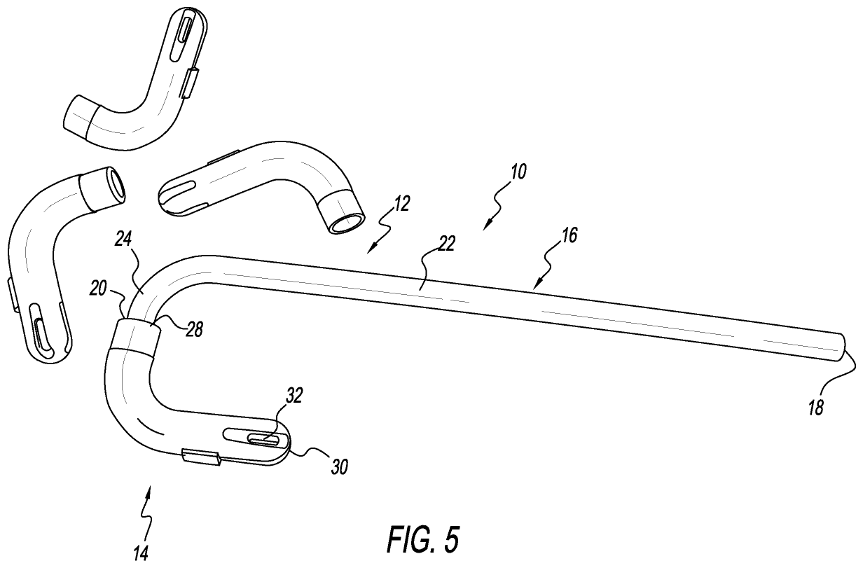

### DETAILED DESCRIPTION OF THE PREFERRED EMBODIMENTS

Referring to the Figures, a saliva ejector 10 has a first member 12 and a second member 14. The first member 12 is comprised of a cylindrical tube 16 having a first end 18 and a second end 20. The tube 16 has a first section 22 that is straight and extends from the first end 18 toward the second end 20 and terminates in second section 24 that is curved or angled in relation to the first section 22. While the curve or angle between the first section 22 and the second section 24 is of any degree, in one example the second section 24 is ninety degrees in relation to the first section 22. The first end 18 is connected to a SVE line 26 and the second end 20 is connected to the second member 14. The first member 12 is made of any material such as a hard plastic, metal, or combination of both.

The second member 14 includes a tube having a closed outer or first working end 28, and an open second end 30. The second member 14 is made of a rigid material such as a hard plastic, metal, or combination of both. In one example, the second member 14 is curved or angled such that the first working end 28 is perpendicular in relation to the second open end 30. The working end 28 has a pair of slits 32 adapted to allow for the evacuation of fluid (water or saliva) from a patient's mouth and is either straight, curved or angled. The second end 30 is removably and rotatably connected to the second end 20 of the first member 12. The second end 30 is connected in any manner. For example, the second end 30 may fit over the second end 20 in a friction fit secure enough to maintain the connection while permitting rotation of the second end 30 in relation to the first member 12. In another example the second end 30 has a plurality of stops 34 positioned radially on an inner surface 36 of the second end. The stops 34 are positioned to selectively align and engage with a locking groove 38 on the second end 20 of the first member 12. Any number of stops 34 and grooves 38 can be used and in the example shown there are four stops 34 that correspond to four positions for the second member 14 in relation to the first member 12.

In operation, the first member 12 of the saliva ejector is connected to the SVE line 26 in any manner such as by a snap fit. The second member 14 is attached to the first member 12 by placing the second end 30 of the second member 14 over or within the second end 20 of the first member so that one of the stops 34 of the second member 14 is engaged and connected to the locking groove 38 of the second end of the first member 12. The second member 14 is rotated about the first member so that other stops engage and connect with the locking groove 38 for different positions. In one example, the second member 14 has a first or inward position where it curves back toward the first member 12 to be in a spaced parallel direction to the first member 12 forming a J-shape, a second or left position where the second member 14 extends transversely in relation to the first member 12, a third or right position where the second member 14 extends transversely in relation to the first member and in a direction opposite the left post, and a fourth or outward position where the working end 28 of the second member 14 extends away from the second section 24 of the first member 12 in a direction opposite the first end 18 of the first member to form an S-shape. The ability to change the position of the second member 14 in relation to the first member 12 is critical when suction and retraction are needed simultaneously. This is particularly important as during a dental procedure not only is the position of the saliva ejector in relation to a patient's mouth will vary, but the position of the dental technician as related to the patient may change as well.

Accordingly, a saliva ejector has been disclosed that at the very least meets all the stated objectives. From the above discussion and accompanying figures and claims it will be appreciated that the saliva ejector 10 offers many advantages over the prior art. It will be appreciated further by those skilled in the art that various other modifications could be made to the device without parting from the spirit and scope of this invention. All such modifications and changes fall within the scope of the claims and are intended to be covered thereby. It should be understood that the examples and embodiments described herein are for illustrative purposes only and that various modifications or changes in the light thereof will be suggested to persons skilled in the art and are to be included in the spirit and purview of this application.

What is claimed is:

1. A saliva ejector, comprising:
a first member having a first end and a second end, wherein the first member has a first section that extends from the first end and terminates in a second section that is angled in relation to the first section;
a second member rotatably and removably connected to the second end and having a first working end that is perpendicular in relation to a second open end.

2. The ejector of claim 1 wherein the first section of the first member is straight.

3. The ejector of claim 1 wherein the second section is ninety degrees in relation to the first section.

4. The ejector of claim 1 wherein the second member is made of a hard plastic material.

5. The ejector of claim 1 wherein the first working end of the second member has a plurality of slits adapted to allow for the evacuation of fluid from an individual's mouth.

6. The ejector of claim 1 wherein the second member is connected to the first member by a friction fit.

7. The ejector of claim 1 wherein the second open end of the second member has a plurality of stops positioned on an inner surface of the second open end that selectively align and engage with a plurality of locking grooves on the second end of the first member.

8. The ejector of claim 1 wherein the second open end of the second member has four stops radially positioned on the inner surface of the second open end.

9. The ejector of claim 1 wherein the second member is rotated in relation to the first member to form an S shape.
